(19) United States
(12) Patent Application Publication
(10) Pub. No.: US 2013/0103433 A1
(43) Pub. Date: Apr. 25, 2013

(54) AUTOMATED INSURANCE SYSTEM

(71) Applicant: Snowfall Cotter Pty Limited, Wollstonecraft (AU)

(72) Inventors: Robert J. Corben, Helensburgh (AU); Craig Hathaway, Wollstonecraft (AU)

(73) Assignee: SNOWFALL COTTER PTY LIMITED, Wollstonecraft (AU)

(21) Appl. No.: 13/716,805

(22) Filed: Dec. 17, 2012

Related U.S. Application Data
(63) Continuation of application No. 12/741,264, filed on Jun. 3, 2010.

(30) Foreign Application Priority Data
Nov. 5, 2007 (AU) 2007906058

(51) Int. Cl. G06Q 40/08

(52) U.S. Cl. CPC G06Q 40/08
USPC 705/4

(57) ABSTRACT

There is disclosed an automated management system for an insurance policy issued by an insurance provider to a policy holder. The system comprises a computer-based database for items covered by the policy, interfaces for inputting data into the system and/or database, and a Rules Engine, for checking input data against pre-defined rules. An Event Engine is configured to be actuated by a rules outcome effected by the Rules Engine, and/or data that is input via the interface. The Event Engine, when actuated, effects a pre-determined outcome event in relation to the insurance policy.

### TECHNICAL FIELD

The present invention relates to a system for automatically managing insurance policies of policy holders. In particular, a system according to an embodiment of the invention relates to an online insurance policy inventory management system particularly suited to home contents insurance.

### BACKGROUND OF THE INVENTION

Conventional insurance products are sold via a distribution model having very limited interaction between the insurance providers and the insurance policy holders. Such conventional insurance models can result in the policy holders being drastically underinsured and also results in the insurance providers having relatively high operational costs and relatively time consuming insurance claims.

For example, there were approximately 7,855,600 households in Australia in April 2005. Of this number of households, approximately 14% (1.099 million) had no insurance cover protecting their assets at all. Of the remaining households that did have some level of insurance protection, a substantial number had undervalued their insurance policies for their household contents. As a result of the huge scale of servicing the insurance policies of more than 6 million households, conventional insurance providers are unable to have much control over the level of protection that is afforded to insurance policy holders, for ensuring that the protection is of the proper value and appropriateness. Responsibility for achieving the desirable level of appropriateness of insurance policies, and for reviewing such policies, is largely left in the hands of the policy holders themselves.

With conventional insurance products, consumers (prospective insurance policy holders) are provided with calculation tools to help them estimate values for their policies. These tools do not take into account the specifics of the individuals but are generic category calculators and/or are driven by statistically derived profiles.

Once a value is estimated, it is confirmed with the insurance policy provider, the policy is purchased, and the transaction is completed. It is estimated that for one in twenty (5%) Australians, it will be at least five years before they next update their contents insurance policies.

Currently, after a predetermined amount of time has passed following the purchase of a contents insurance policy, the insurance provider typically sends a policy reminder to the policy holder. This policy reminder is sometimes the first and only time that the insurance provider contacts its policy holders. Renewal notices may contain messages to the holders advising them to check the current status of their insurance, but it is usually the policy holders' own responsibility to self-assess their needs, estimate new values for the insurance, or accept an arbitrary consumer price index (CPI)-based increases to the previous years' values.

After re-evaluating their insurance needs, the policy holders normally send details of required changes in their policies back to the insurers. The insurers may accept the changes or further adjust the values of the policies.

Typically, policy holders then store away their policy files until the next time the renewal of their insurance policies are due, or until the policy holders need to make insurance claims.

In the event that an insurance claim is made, the insurer checks the policy and assesses whether the items to which the claim relates meet the terms and conditions of the insurance contract. After that, the insurer may initiate the claim process, which typically entails applying standard claim assessments, processing claim payments, and allocating compensation where appropriate.

The conventional business model for contents insurance is error-prone and expensive. There is also much duplication of effort by the parties involved. The insurance providers' financial margins are often reduced due to the need for rework and due to predominantly paper-based systems.

Also, when the amount of the insurance purchased for a policy does not adequately cover the value of the assets to which the policy relates, those assets are underinsured. This is, of course, a problem for the insurance policy holders when insurance claims are made, because their insurance policies often do not adequately cover the costs of replacing or repairing all goods for which claims may be made.

Lack of appropriate analysis when the insurance is purchased, compounded with a lack of ongoing review, leaves policy holders having to guess the value of their assets, as well as having the responsibility of keeping paper-based records of transactions should a claim ever be made. Home computer systems and filing cabinets are generally not suited to storing such information.

The processing of insurance claims is historically slow and drawn-out. Policy holders usually have to verify all items in relation to which a claim is made, often with reference to proof of purchases such as receipts. Costs and delays are high. Litigation and arbitration are often required to resolve disputes.

There is currently no effective method that will automate the initial calculation of the sum insured using “real” data when a policy is purchased, revalue the portfolio of assets, and automatically keep the insured sum up-to-date with the homeowner's specific portfolio of assets.

To calculate premiums each year, insurance providers often consider advice from actuaries regarding total amounts (pool amounts) that the providers should collect (by way of insurance premiums) to fund claims that may occur in the coming financial year. Using a normal business model—even with the best analysis and modelling—the estimate of a pool amount could prove, over time, to be above or below the amount needed. Forecasting actual costs of claims in the coming year is difficult and always involves a significant degree of uncertainty.

The insurance system of the present invention may assist in more accurately estimating premium pools, as it takes into account, to a far greater degree, specific items covered by each policy, as the system enables the listing of these, and insurance claims can be verified in relation to data stored within the insurance system. Being able to forecast a more accurate premium pool should assist in achieving more precise premium calculations.

A more rigorous method of calculation of the initial sum insured for people seeking insurance protection, and an effective means of reducing the chance of underinsurance, may have the added benefit of increasing the number of people prepared to acquire insurance policies to adequately cover their assets. More accurately determined premiums pool may also have the related benefit of more accurate actuarial assessments of risk. These factors may assist in achieving large-scale reductions in the amount of premiums for contents insurance.

It is an object of the present invention to provide an insurance system which will overcome or ameliorate at least some of the deficiencies in the prior art, or which will at least provide an alternative thereto.

### SUMMARY OF THE INVENTION

According to a first aspect of the invention there is provided an automated management system for an insurance policy issued by an insurance provider to an insurance policy holder, said system comprising:
a computer-based item database for storing details of items covered by said insurance policy;
at least one interface configured for enabling the inputting of data into at least one of said system and said database;
a Rules Engine, which is configured to check data that is input via said at least one interface against pre-defined rules, and to effect a rules outcome based on the nature of said input data and said pre-defined rules; and
an Event Engine, which is configured to be actuated by, and based on, an actuating event being at least one of
   a rules outcome effected by said Rules Engine, and
   data that is input via said at least one interface,
to effect a pre-determined outcome event in relation to the insurance policy.

In a preferred embodiment, said interface is a point-of-sale interface which is configured for automatic inputting of said data by transmitting the data to the online item database, the data pertaining to a transaction for the purchase of at least one item by or for a said particular policy holder at the point-of-sale interface.

Preferably, said data includes at least one of the following:
insurance system account identification (ID) number;
name of said particular policy holder;
retail store identification details;
identification details of each manufacturer of the at least one purchased item;
brand, model and/or serial number of the at least one purchased item;
warranty details of the at least one purchased item;
unit value of the at least one purchased item;
total value of the items purchased during said transaction;
payment method used during said transaction; and
date and time of said transaction.

Preferably, said data is transmitted from said point-of-sale interface to said online item database in batch mode.

Preferably, said data is transmitted using one of the following:
XML transmission, and
Web Services technology transmission.

In a preferred embodiment, said data includes at least one of the following:
details of items covered by said insurance policy; and
parameters of the pre-defined rules.

In a preferred embodiment, said actuating event is at least one of the following:
a new insurance policy application by a prospective said policy holder;
an adjustment of an existing insurance policy;
a change of details of the policy holder; and
lodgement of an insurance claim by or for a said policy holder.

In a preferred embodiment, said pre-defined rules include at least one of:
product disclosure statement (PDS) rules of the insurance provider; and
business rules of the insurance policy provider.

Preferably, the automated management system is configured to enable the insurance provider to amend the pre-defined rules via the at least one interface.

In a preferred embodiment, said at least one interface includes an inventory management interface, which allows the insurance policy holder to perform at least one of the following steps:
manually amend details of said items stored in the item database; and
lodge an insurance claim.

In a preferred embodiment, the item database is configured to store said details of items covered by said insurance policy in encrypted form.

In a preferred embodiment, the Event Engine is adapted to effect an outcome event which includes sending at least one of the following to a destination designated for a policy holder:
a short message service (SMS) message; and
an email.

In a preferred embodiment, the Rules Engine is configured to periodically update details stored in said item database based on data received via said at least one interface.

Preferably, the automated management system is configured to receive, via said at least one interface, data relating to current market values for items, details of which are stored in said item database, and to perform said periodic update by adjusting said details stored in the database relating to values attributed to those items, based on the received data.

In a preferred embodiment, the Rules Engine is configured to store information and to use such information to effect said pre-determined outcome, wherein the information includes at least one of the following:
commencement date of said insurance policy;
ceasing date of said insurance policy;
another date pertaining to said insurance policy;
age of the policy holder;
details pertaining to safeguarding of said items;
crime rates for areas in which said items are kept;
general product disclosure statement (PDS) rules of the insurance provider;
insured value thresholds for said items;
specific item inclusions and exclusions;
attributes of items in the form of property to which the insurance policy relates; and
details of rental or ownership by the policy holder of said property.

In a preferred embodiment, the automated management system includes an insurance premium quote engine for automatically determining insurance premiums payable for said insurance policy based on said details stored in said item database.

Preferably, the insurance premium quote engine is configured to automatically calculate a new insurance premium for an insurance policy held by a policy holder, in response to data received via said at least one interface, and to effect communication of said new premium to a predetermined destination for said policy holder.

In a preferred embodiment, the automated management system includes a response messaging unit adapted to generate and transmit to a predetermined destination for a said policy holder, predetermined details of that policy holder's policy, said predetermined details including at least one of the following:
details of the status of the policy;
details relating to premium payments for the policy; commencement
and ceasing dates of the policy; and
comments of an administrator of the policy.

In a preferred embodiment, the insurance policy is at least one of a household insurance policy and a business contents insurance policy.

According to a second aspect of the invention, there is provided an automated process for insuring an item with an insurance policy issued by an insurance provider to an insurance policy holder, using an automated management system adapted for management of said policy, the process including the steps of:
(i) receiving, via a point-of-sale interface of said system, data pertaining to a transaction for the purchase of the item by or for a particular said policy holder, said transaction occurring at a point-of-sale of a retail store;
(ii) detecting said receipt as an actuating event by an Event Engine of said system and effecting an event outcome which involves causing details of said receipt to be transmitted to a Rules Engine of the system;
(iii) checking said received data, by the Rules Engine, against pre-defined rules, and effecting a rules outcome based on the nature of said received data and said pre-defined rules;
(iv) if permitted by the rules outcome, effecting a further event outcome based on said rules outcome, said further event outcome causing said data to be stored in a computer-based item database of said system and details of said purchased item to be transmitted to an insurance premium quote engine of said system;
(v) calculating, by said insurance premium quote engine, a new insurance premium payable by the policy holder in relation to said policy; and
(vi) communicating, by said insurance premium quote engine, said new premium to a predetermined destination for said policy holder.

In this specification, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

In this specification, were reference is made to information being sent or transmitted to a destination, then unless the context requires otherwise, this includes a physical destination or address, an email address or other address or number for electronic communications

### BRIEF DESCRIPTION OF DRAWINGS

The invention is now discussed by way of example only with reference to drawings, where:

FIG. 1 is a flow and block diagram showing a first aspect of an insurance system according to an embodiment of the present invention.

FIG. 2 is a flow diagram showing sequential operation of aspects of the insurance system of FIG. 1;

FIG. 3 is a diagram showing a conceptual representation of the insurance system of FIG. 1; and

FIG. 4 is a diagram showing a functional representation of the insurance system of FIG. 1.

### DETAILED DESCRIPTION OF PREFERRED EMBODIMENTS

### Overview of Aspects of the Invention

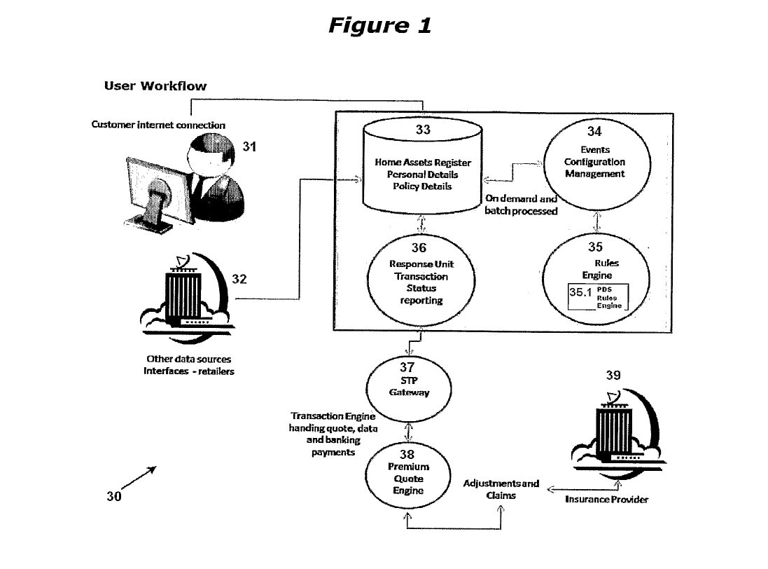

Referring to FIG. 1, one aspect of this invention relates to a computer based insurance policy management system 30. The system 30 is for automatically managing aspects of home contents insurance policies that are issued by insurance providers 39 to policy holders 31, to assist the holders in relation to such policies.

The system 30 is adapted for tracking updates of the assets insured under the insurance policies and for updating other information relating thereto. For example, the insurance system 30 may receive data relating to the assets from external information systems 32, such as those operated by retail stores, when the policy holder purchases new items from such stores.

The insurance system 30 includes a Rules Engine 35 and an Event Engine 34. On receipt of such above-mentioned data, the Rules Engine 35 is adapted to check the data against pre-defined rules and to effect a rules outcome based on the nature of the data and the rules.

For example, the Rules Engine 35 may determine whether the Event Engine 34 is to perform a re-evaluation event for re-assessing the items listed in the insurance policy, or adjusting the premiums of the insurance policy, based on the items listed or other data such as market related data that affects the value of the items.

If such a re-evaluation event does occur, then the insurance system 30 may automatically renew the insurance policy with the insurance provider 39. As a result, the insurance policies managed by the insurance system 30 may be kept in line with current market values to assist in providing adequate cover for the replacement costs of items covered by the insurance policy.

### Details of the System

Other components of the insurance system 30, as shown in FIG. 1, include an Asset Database 33, a Response Messaging Unit 36, an STP Gateway 37 and Premium Quote Engine 38.

In one embodiment, the Event Engine 34 monitors events that occur in relation to a contents insurance policy and triggers pre-determined outcomes (processes) when certain events occur. The system 30 provides an interface (not shown) that can be accessed by the insurance provider to define and administer a selection of rules concerning the events that can occur in relation to an insurance policy.

The function of the Event Engine 34 is to automatically keep track of events that may occur in relation to an insurance policy (such as new data being entered) and then, for most types of event based on outputs from the Rules Engine 35, to initiate a pre-determined process based on the event, such as a re-evaluation process.

The Event Engine 34 may be adapted to effect pre-determined processes, based on outputs from the Rules Engine 35, triggered by events involving input from the insurance policy holder 31, and to allow the holder to configure aspects of the process in relation to the holder's insurance policy. For example, the event may involve the submitting an insurance claim by the policy holder 31, in response to which the Event Engine 34 may trigger an insurance claiming process which allows input of details of the claim by the holder.

The Event Engine 34 may, for most events involving outputs from the Rules Engine 35, also trigger the insurance system 30 to send Short Messages

Services (SMS) messages, emails, or other suitable messages, to alert policy holders, or other parties such as policy holders' brokers, of events that have occurred in relation to an insurance policy.

The Event Engine 34 also deals with events involving input from policy holders 31 for defining parameters affecting the holders' insurance policies, such as important policy dates (e.g. commencement and ceasing dates of the policies), ages of the policy holders, and attributes of insured properties (e.g. rental or ownership status)

The Event Engine 34 may also deal with events involving input from other, external sources (such as government bodies, statistical sources, insurance bodies, etc), for example where such inputs include data relating to security levels, crime rates for particular neighbourhoods, general product disclosure statement (PDS) rules, asset value thresholds, and specific asset inclusions and exclusions, etc.

In addition, the Event Engine 34 may be adapted to respond to certain predefined events involving the general “Business” rules of a particular insurance provider or insurance policy.

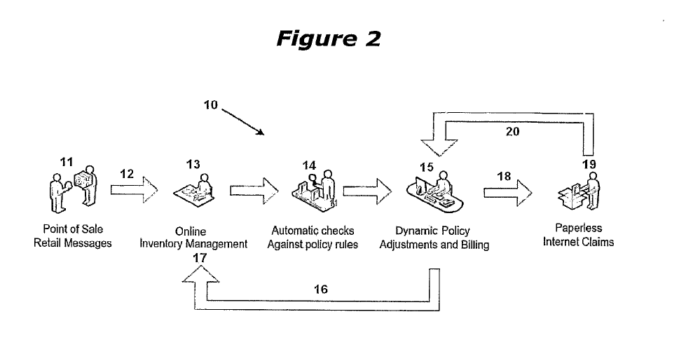

As best shown in FIG. 2, External Asset Interfaces 11 are integrated into point-of-sale systems of retailers, and are adapted to connect, and communicate, with a remainder of the insurance system 30.

The External Asset Interface 11 functions in a similar way to middleware (computer software that connects software components or applications) and is adapted to deliver standard format messages to the insurance system 30. This format is designed for retailers to transmit standard format messages to the infrastructure of the insurance system 30 from the retailers' point-of-sale software.

Such standard format messages may include details of the items (assets)—i.e. retail products—purchased from the retail stores, and other information to enable such transmitted data to be suitably used by the system 30 in relation to the insurance policies of policy holders. For example, such a message may include the following information:
insurance policy account identification (ID) number, and the name of the person who purchases the goods from the retail store;
identification details for the retailer;
manufacturer details for the purchased products, brand names of the purchased products, model and serial numbers of the purchased products;
warranty details of the purchased products;
unit values of the purchased products;
total value of the purchased products;
the payment method used (such as cash, cheque, credit card, etc.);
date and time of the purchase.

One example of the standard message format is XML.

Since the purchase records are obtained direct from the retailers, the policy holders do not have to keep their purchase receipts in case insurance claims need to be made in future.

As another example, the External Asset Interface 11 uses Web Services technology for transmitting messages to the insurance system 30.

According to a preferred embodiment, the transmission 12 of information from the retail store, via the External Asset Interface 11, to the remainder of the insurance system 30, is carried out in batch mode, typically overnight after the close of business each day. Alternatively, it may be carried out at the end of each week. As a further alternative, the transmission 12 is carried out “on demand”, for example each time a retail purchase is made.

The insurance system 30 stores updated information in the Asset Database 33 after the information is checked and evaluated by the Rules Engine 35. The data that is stored is preferably encrypted.

The insurance system 30 may also provide secure communication with other parties, such as policy holders themselves or their brokers, third party retailers, manufacturers, other insurance providers and governmental bodies and departments.

The insurance system 30 also includes an inventory management interface 14 to enable the policy holder 31 to manage the insurance policy, e.g. to update the holder's details. For example, the policy holder 31 can make manual adjustments such as adding, deleting or editing the data stored in the Asset Database 33.

In particular, when new items have automatically been added to the insurance portfolio of a policy holder 31 by way of data supplied to the insurance system 30 from retailers, the policy holder may elect to verify the details of the items that have been automatically added. Policy holders 31 may also access their insurance history information via the inventory management interface 14.

If a policy holder 31 manually adds an item to the Asset Database 33 for his insurance policy by using the inventory management interface 14, it is possible that the holder may not enter the correct value of the item. In this case, the insurance policy might not adequately cover the value of all of the items covered by the insurance policy. To minimise the chance of this occurring, according to a preferred embodiment, parameters of a predetermined event are pre-programmed into the Event Engine 34. Such parameters configure the Event Engine 34 to periodically re-assess the value of the items listed in Asset Database 33 and to set premiums accordingly.

This predetermined event also minimises inadequacy of, or inaccuracy in, the extent of insurance cover that may arise due to inflation and other movements in the economy. For example, when the market values of the insured items change, the Event Engine 34 automatically adjusts the insurance premiums according to the current market values of the assets.

This not only assists in ensuring that insurance policies suitably cover the current value of the insured assets, but also provides more accurate information for the insurance providers to forecast “Premium Pools”. The Premium Pool is the overall amount needed to fully fund all claims expected to be paid in the coming year for a particular line of business.

### Checking Data Against Rules

When information is entered into the Asset Database 33, the data is checked, by the Rules Engine 35, against a set of rules which apply to the data. The term “rules” refers to a collection of rules pre-programmed or entered into the system 30, which relate to or affect aspects of the insurance, such as the value of assets covered by the insurance.

For example, the Rules Engine 35 may check whether the combined total value of the assets listed in the Asset Database 33 is less than, or equal to, the total value of the insurance policy.

Part of the rules defined in the Rules Engine 35 are product disclosure statement (PDS) rules. While “Business Rules” are a set of rules applied by the system 30 but which are generic and therefore not specific to a particular policy provider or product provided by that provider, the PDS Rules do apply to a specific product of a provider.

Thus, as illustrated in FIG. 1, the Rules Engine 35 (in particular the PDS components thereof, referred to below as the PDF Rules Engine 35.1) may also check whether the items listed in the Asset Database 33 are at odds with the predefined PDS rules or whether the PDS rules in any other way affect or have a bearing on the entered data. The Rules Engine 35 is a system that executes all business rules, including rules that identify which particular PDS rules apply to a particular scenario. Thus, the Rules Engine 35 includes, as one of its features, a process workflow control.

By comparison, the PDS Rules Engine 35.1 is a system that executes the PDS rules, as they apply to a specific product of a particular policy provider, where such a product constitutes the policy held by a policy holder 31. This may be explained by way of the following example, which sets out a particular insurance scenario.

### Example

Joe Plumber, the policy holder, owns a Home and Contents insurance policy (policy number #SPL0002) issued by Insurance Provider X. The type of insurance policy (i.e. the product of Insurance Provider X) is its “Accidental Damage” product.
The PDS Rules Engine 35.1 of the system 30 includes a set of PDS rules for the “Accidental Damage” product of Insurance Provider X.
One of the PDS rules for that product, rule #1, provides that battery-powered items are only covered to a value of $2,500 (per item).
Joe Plumber purchases an item at a retail outlet, details of the item being entered into the system 30 as described above.
The entered details are then processed by the Business Rules Engine 35, according to the following workflow checks:
   Is the item linked to a recognised set of PDS rules?
      If “No”, the business rule is satisfied so that the item can be entered as an insured item on the Asset Database 33
      If “Yes”, Continue to PDS Rule #1
At this stage, details of the item are submitted to be processed by the PDS Rules Engine 35.1, according to the following workflow checks:
   Is the item battery-powered?
      If “No”, the PDS rule is satisfied so that the item can be entered as an insured item on the Asset Database 33
      If “Yes”, Continue to the next step of the PDS Rules Engine workflow, as follows:
   Is the item value greater than $2,500?
      If “No”, the PDS rule is satisfied so that the item can be entered as an insured item on the Asset Database 33
      If “Yes”, the PDS is not satisfied so that the item cannot entered as an insured item on the Asset Database 33
Finally, the system 30 notifies the Joe Plumber of the above outcome (using a Response Messaging Unit 36 as discussed below).

Thus, when a policy holder 31 enters new data into the system 30 via the inventory management interface 14, the data is checked by the PDS Rules Engine 35.1 for verification and validation. The PDS Rules Engine 35.1 contains the PDS rules of the insurance policy.

According to one preferred embodiment, the PDS Rules Engine 35.1 controls all data flow, data logic and the transaction interface of the insurance system 30. The PDS Rules engine 35 accepts data from three data input sources:
Data Store, which provides variables and constants inherent in the PDS rules;
Policy Values, which are the actual tracked values of the assets; and
Policy Holder Information, which includes details of the policy holders, such as their names, dates of birth, addresses, etc.

After the PDS Rules engine 35 processes the input data, it provides a pre-defined response (a rules outcome) that is based on the results of the verification/validation process.

The PDS Rules engine 35 includes an error management facility to handle errors occurring in the data verification/validation process, for example by causing a suitable message to be transmitted to the policy holder 31 or the holder's broker.

When data is entered, and the PDS Rules Engine 35.1 has checked the data and verified or validated it, then based on that checking process, PDS Rules Engine effects a suitable action which for many situations will trigger the Event Engine 34. When triggered, the Event Engine 34 will automatically check what new event has occurred, such as a new insurance policy application, an insurance policy adjustment, a change of the policy holder's name or other details, or if an insurance claim has been lodged.

The Event Engine 34 will initiate the predetermined process corresponding to the particular event that has occurred.

Where the nature of the event based on new input data is such that a reassessment of the policy is caused to occur by the Event Engine 34, data is then passed to a Premium Quote Engine 38 to generate new premium quotes for the updated insurance policy.

The policy holder 31, after reviewing the new quote for the updated insurance policy, may then accept the premium quote and make a suitable payment. The insurance system 30 provides a number of conventional payment options to pay the premium, such as credit card payment, electronic funds transfer, etc.

If, after reviewing the revised premium quote, the policy holder 31 wishes to make further adjustments to the insurance policy, the holder can make the suitable data inputs via the inventory management interface 14, and the process of verification/validation in relation to these inputs, and consequential actions by the Event Engine 34, are repeated, and new premium quotes are calculated by the Premium Quote Engine 38.

In a preferred embodiment, the Premium Quote Engine 38 has an interface for allowing access by, and communications with, external insurance systems. In this way, the Premium Quote Engine 38 can process quotes, make or receive insurance claims and effect other transactions for external insurance systems.

When a policy holder is satisfied with a premium quote that has been automatically generated by the Premium Quote Engine 38 and has paid the insurance premium, the Event Engine 34 will automatically continue to monitor events.

To improve the efficiency of the insurance system 30, premium quotes may be transmitted to policy holders 31 via a Straight Through Processing (STP) Gateway 37. The premium quotes and other associated information are formatted into standard messages for automatic transmission. The information transmitted with the premium quotes includes the policy number, policy holder name, quote reference number, authorisation code, current sum insured and the new sum insured. With the STP Gateway 37, the settlement of the insurance policy may be completed relatively quickly, possibly even on the same day that the new quote is transmitted.

The Response Messaging Unit 36 facilitates reporting to the policy holder 31 and maintenance of the insurance policy status. The Response Messaging Unit 36 is adapted to accept information from the insurance provider. When the Response Messaging Unit 36 receives a message from the insurance provider, it generates a feedback report to the policy holder or the holder's insurance broker, in relation to that communication from the insurance provider. Typically the messages are transmitted using web services such as WSDL, SOAP and/or XML. A feedback report contains the following information:
status of the insurance policy, such as pending, confirmed, awaiting underwriting, rejected, cancelled by policy holder, etc.;
details of payments made or to be made;
relevant and effective dates, such as commencement and ceasing dates of the insurance policy; and
administrator comments.

The insurance system 30 is also adapted to assist with the making of insurance claims, as the policy holder 31 may initiate an insurance claim via the insurance system. An insurance claim may be one of the predetermined events which the Event Engine 34 is configured to monitor.

When a claim is made, the insurance system 30 generates an electronic claim report and sends it electronically to the relevant parties. The generated claim report may be a standard format such as PDF or XML. Data relating to the claim and the claim report are sent to the insurance provider via the STP Gateway 37. Hence, no hard copy of the insurance claim is required to be sent, and accordingly, the insurance claim can be settled relatively quickly, usually on the same day that the claim is made.

The insurance provider can then assess the claim based on the data submitted, and can respond to the policy holder via the STP Gateway 37. As the insurance system 30 will have been provided with accurate details of the insurance policy (as discussed above), the insurance provider can readily obtain relevant data electronically from the Asset Database 33, and thus facilitate and speed up the insurance claim process.

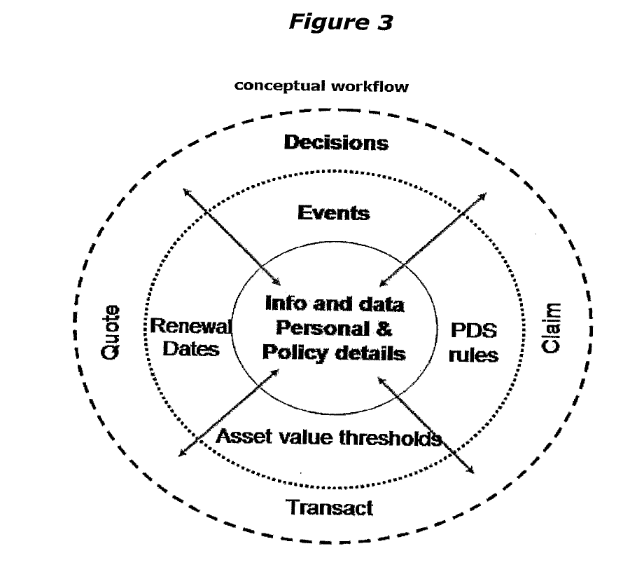

FIG. 3 is a conceptual workflow of the insurance system 30. The centre of the workflow represents the information and data stored in the Asset Database 33. The insurance system 30 receives data from the policy holder, insurance providers and retailers. The data is then applied to generate events, which are monitored by the Event Engine 34. The PDS Rules Engine 35.1 checks entered data against the predefined rules (for example, in relation to asset value thresholds and renewal dates of the policy).

According to one embodiment, the “core” of the insurance system 30 comprises the Asset Database 33, PDS Rules Engine 35.1, and the Response Messaging Unit 36. The STP Gateway 37 and Premium Quite Engine 38 may be external, third party proprietary systems, which are connected to the “core” of the insurance system 30.

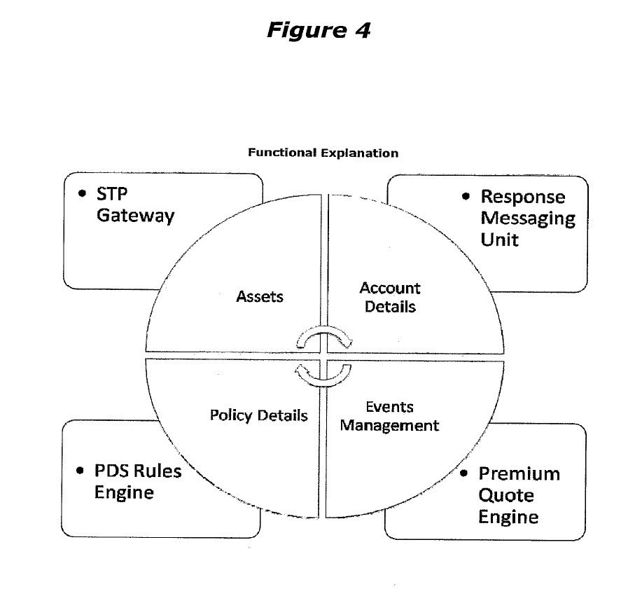

As shown in FIG. 4, the “core” of the insurance system 30 (represented by the encircled details and the components labelled as the “PDS Rules Engine” and “Response Messaging Unit” in that figure) interfaces with an STP Gateway and Premium Quite Engine which form part of external insurance provider systems for quoting, claims, and transactional purposes. However, it should be understood that in other embodiments (not shown), the insurance system 30 may include the STP Gateway 37 and Premium Quote Engine 38 as part of its “core”.

It is envisaged that the insurance system 30 will be able to be used by a policy holder 31 to manage multiple insurance policies issued by different insurance providers. For example, the policy holder 31 may choose one insurance policy to cover one particular item, such as a car, and a different insurance policy to cover a second item, such as a television set. Such policies may be provided by different insurance providers. The insurance system 30 may thus allow the policy holder to choose specialist insurance providers to insure specific items to minimise risk, while maintaining a central insurance database and a single insurance interface.

### Example

According to an example which is described with reference to FIG. 2, an insurance policy holder named Michael buys a new 50″, high definition, LCD television set from a retail store, “Televisions for Less Pty Ltd”. Televisions for Less Pty Ltd then forwards details of the transaction to the insurance system 30. An External Asset Interface 11 is integrated into the retail system of Televisions for Less Pty Ltd, and is configured to communicate with a remainder of the insurance system 30.

One type of event which the Event Engine 34 is configured to deal with is the purchase of a new item by the insurance policy holder 31. According to this example, the Event Engine 34 automatically identifies that a new purchase has been made by the policy holder, and triggers the process for re-evaluation of the insurance policy, taking into account the newly purchased item.

In such a case where the item purchased is relatively expensive, in this case a 50″, high definition LCD television set, the Premium Quote Engine 38 is configured to calculate a new premium to cover the current value of the assets listed in Michael's insurance policy, including the new television set that he has just purchased. This assists in reducing the risk of Michael under-estimating the value of his insurance policy. [is it correct that the new premium is calculated by the Event Engine 34? Is it not by the Premium Quote Engine? What is the role of the Rules Engine 35 in this example?]

In this example, the PDS Rules Engine 35.1 contains a rule relating to the particular insurance policy, specifically pertaining to high value assets. The rule places a cap on payments in the event of theft, accident and/or other damage. If this cap is a payout limit of $5,000 for electrical items, then a $15,000 high-definition LCD television set will be ineligible for a claim.

Further, if the total insured value of all assets covered by the policy is $100,000, and prior to the purchase of this asset the sum of all assets was $95,000, then this purchase (assuming that the value of the television set is $15,000) will result in a need for the total value of insurance to be $110,000. Inclusion of this as one of the assets covered by the policy can therefore affect not only the eligibility of the television set to be covered by an insurance claim under the policy, but can also put at risk all other assets covered by the policy.

It will therefore be appreciated that the PDS Rules Engine 35.1 determines the insurance status of this new asset (i.e. the television set) as an individual item, but also the impact of this purchased item on the entire group of assets insured.

In another embodiment of the present invention, the insurance system 30 is configured to provide an interface (not shown) for uploading digital data, such as images, electronic files, and electronically scanned documentation, to the Asset Database 33, for storing those items. Typically those stored items relate only to the contents of insurance policies. However, the insurance system 30 also allows a policy holder to upload images of non-insured assets or items, such as family photographs and paper-based memorabilia, for these to be stored in the Asset Database as backup copies.

Although the invention is described above in relation to preferred embodiments, it will be appreciated by those skilled in the art that it is not limited to those embodiments, but may be embodied in many other forms.

For example, while a point-of-sale at a retailer is referred to as a source of data transmitted to the system 30 when the policy holder 31 purchases a new item (asset), data may emanate from other sources. For example, a credit card provider may provide such data when a card from that provider is used in the transaction.

In addition, while the invention is described above in relation to home insurance, it may be used for other types of insurance such as business contents insurance or even health insurance. In the case of health insurance, the items covered by the health insurance, instead of assets as covered by the home insurance described, may include particular diseases or ailments or methods of treatment, or products used in relation to such diseases, ailments or methods, or other items of healthcare or pharmacy.

1. An automated management system for an insurance policy issued by an insurance provider to an insurance policy holder, said system comprising:
a computer-based item database for storing details of items covered by said insurance policy;
at least one interface configured for enabling the inputting of data into at least one of said system and said database;
a Rules Engine, which is configured to check data that is input via said at least one interface against pre-defined rules, and to effect a rules outcome based on the nature of said input data and said pre-defined rules; and
an Event Engine, which is configured to be actuated by, and based on, an actuating event being at least one of
a rules outcome effected by said Rules Engine, and
data that is input via said at least one interface,
to effect a pre-determined outcome event in relation to the insurance policy.

2. An automated management system according to claim 1, wherein said interface is a point-of-sale interface which is configured for automatic inputting of said data by transmitting the data to the online item database, the data pertaining to a transaction for the purchase of at least one item by or for a said particular policy holder at the point-of-sale interface.

3. An automated management system according to claim 2, wherein said data includes at least one of the following:
insurance system account identification (ID) number;
name of said particular policy holder;
retail store identification details;
identification details of each manufacturer of the at least one purchased item;
brand, model and/or serial number of the at least one purchased item;
warranty details of the at least one purchased item;
unit value of the at least one purchased item;
total value of the items purchased during said transaction;
payment method used during said transaction; and
date and time of said transaction.

4. An automated management system according to claim 2 claim 3, wherein said data is transmitted from said point-of-sale interface to said online item database in batch mode.

5. An automated management system according to claim 2 wherein said data is transmitted using one of the following:
XML transmission, and
Web Services technology transmission.

6. An automated management system according to claim 1, wherein said data includes at least one of the following:
details of items covered by said insurance policy; and
parameters of the pre-defined rules.

7. An automated management system according to claim 1, wherein said actuating event is at least one of the following:
a new insurance policy application by a prospective said policy holder;
an adjustment of an existing insurance policy;
a change of details of the policy holder; and
lodgement of an insurance claim by or for a said policy holder.

8. An automated management system according to claim 1, wherein said pre-defined rules include at least one of:
product disclosure statement (PDS) rules of the insurance provider; and
business rules of the insurance policy provider.

9. An automated management system according to claim 8, configured to enable the insurance provider to amend the pre-defined rules via the at least one interface.

10. An automated management system according to claim 1 wherein said at least one interface includes an inventory management interface, which allows the insurance policy holder to perform at least one of the following steps:
manually amend details of said items stored in the item database; and
lodge an insurance claim.

11. An automated management system according to claim 1 wherein the item database is configured to store said details of items covered by said insurance policy in encrypted form.

12. An automated management system according to claim 1 wherein the Event Engine is adapted to effect an outcome event which includes sending at least one of the following to a destination designated for a policy holder:
a short message service (SMS) message; and
an email.

13. An automated management system according to claim 1, wherein the Rules Engine is configured to periodically update details stored in said item database based on data received via said at least one interface.

14. An automated management system according to claim 13, configured to receive, via said at least one interface, data relating to current market values for items, details of which are stored in said item database, and to perform said periodic update by adjusting said details stored in the database relating to values attributed to those items, based on the received data.

15. An automated management system according to claim 1 wherein the Rules Engine is configured to store information and to use such information to effect said pre-determined outcome, wherein the information includes at least one of the following:
commencement date of said insurance policy;
ceasing date of said insurance policy;
another date pertaining to said insurance policy;
age of the policy holder;
details pertaining to safeguarding of said items;
crime rates for areas in which said items are kept;
general product disclosure statement (PDS) rules of the insurance provider;
insured value thresholds for said items;
specific item inclusions and exclusions;
attributes of items in the form of property to which the insurance policy relates; and
details of rental or ownership by the policy holder of said property.

16. An automated management system according to claim 1, including an insurance premium quote engine for automatically determining insurance premiums payable for said insurance policy based on said details stored in said item database.

17. An automated management system according to claim 16 wherein the insurance premium quote engine is configured to automatically calculate a new insurance premium for an insurance policy held by a policy holder, in response to data received via said at least one interface, and to effect communication of said new premium to a predetermined destination for said policy holder.

18. An automated management system according to claim 1, including a response messaging unit adapted to generate and transmit to a predetermined destination for a said policy holder, predetermined details of that policy holder's policy, said predetermined details including at least one of the following:
details of the status of the policy;
details relating to premium payments for the policy; commencement
and ceasing dates of the policy; and
comments of an administrator of the policy.

19. An automated management system according to claim 1, wherein the insurance policy is at least one of a household insurance policy and a business contents insurance policy.

20. An automated process for insuring an item with an insurance policy issued by an insurance provider to an insurance policy holder, using an automated management system adapted for management of said policy, the process including the steps of:
(i) receiving, via a point-of-sale interface of said system, data pertaining to a transaction for the purchase of the item by or for a particular said policy holder, said transaction occurring at a point-of-sale of a retail store;
(ii) detecting said receipt as an actuating event by an Event Engine of said system and effecting an event outcome which involves causing details of said receipt to be transmitted to a Rules Engine of the system;
(iii) checking said received data, by the Rules Engine, against predefined rules, and effecting a rules outcome based on the nature of said received data and said pre-defined rules;
(iv) if permitted by the rules outcome, effecting a further event outcome based on said rules outcome, said further event outcome causing said data to be stored in a computer-based item database of said system and details of said purchased item to be transmitted to an insurance premium quote engine of said system;
(v) calculating, by said insurance premium quote engine, a new insurance premium payable by the policy holder in relation to said policy; and
(vi) communicating, by said insurance premium quote engine, said new premium to a predetermined destination for said policy holder.
